(19) United States
(12) Patent Application Publication
(10) Pub. No.: US 2006/0064184 A1
(43) Pub. Date: Mar. 23, 2006

(54) Method of selecting a fantasy team for a sporting event

(76) Inventors: Joseph Ream, Villa Park, IL (US); Robert C. Wojcik, Downers Grove, IL (US)

Correspondence Address: Welsh & Katz, Ltd.;Jon P. Christensen, 22nd Floor, 120 South Riverside Plaza, Chicago, IL, 60606, US

(21) Appl. No.: 11/228,878

(22) Filed: Sep. 16, 2005

Related U.S. Application Data
(60) Provisional application No. 60/612,360, filed on Sep. 23, 2004.

(51) Int. Cl. A63F 13/00

(52) U.S. Cl. 700/91; 463/1

(57) ABSTRACT

A method and apparatus are provided for selecting a fantasy team for a fantasy sporting event. The method includes the steps of: a) providing a fantasy team selection processor; b) providing a bidding pushbutton coupled to the fantasy team selection processor for each of a plurality of participants in the fantasy game; c) detecting a bid from a participant of the plurality of participants for a player; d) adding an incremental bid value of the detected bid to a current bid offer; e) waiting a predetermined time period of time and f) accepting the offer. If another bid is received during the predetermined time period, then steps d, e and f are repeated. Otherwise, the bid is accepted and the player is assigned to the participant.

### FIELD OF THE INVENTION

The field of the invention relates to fantasy sporting events and more particularly to selection of fantasy teams.

### BACKGROUND OF THE INVENTION

Fantasy games based upon sporting events are known. Such games are typically based upon the statistics of players within real-world sporting events.

In order to organize and play a fantasy game, a group of fantasy game participants may choose a sport, agree on a scoring protocol and select a set of players that together form a team for each participant. Statistics from actual sporting events for the selected players may be used under the scoring protocol to determine which fantasy game participant wins.

In contrast to actual sporting events, a fantasy team may not include the full complement of players required for an actual game. For example, in a 12 team fantasy football game, at least some but not all, NFL players may be divided among the fantasy game participants. Each fantasy NFL team may require one quarterback, two running backs, three wide receivers and a kicker. Six back-up players may also be selected for those situations where the primary players are injured or sidelined.

Scoring for each fantasy team may be based upon any appropriate statistic (e.g., touchdowns, passes completed, yards gained, field goals, fumbles, etc.). The fantasy participant with the highest total score wins.

While winning a fantasy game may be important for a fantasy game participant, the skill and satisfaction in playing fantasy games may lie in choosing the players. One existing method of choosing players for fantasy teams involves the use of a website, where fantasy game participants may log-on and make offers for desired players. Visitors to the website are given a salary cap to allocate among chosen players. If a fantasy game participant offers too much for one or more players, the participant may not have enough left to offer other qualified players.

While existing methods of selecting players works relatively well, it fails to optimize participant satisfaction during the player selection process. Accordingly, a need exists for a better method and apparatus for selecting players for fantasy teams.

### SUMMARY

A method and apparatus are provided for selecting a fantasy team for a fantasy sporting event. The method includes the steps of: a) providing a fantasy team selection processor; b) providing a bidding pushbutton coupled to the fantasy team selection processor for each of a plurality of participants in the fantasy game; c) detecting a bid from a participant of the plurality of participants for a player; d) adding an incremental bid value of the detected bid to a current bid offer; e) waiting a predetermined time period of time and f) accepting the offer. If another bid is received during the predetermined time period, then steps d, e and f are repeated. Otherwise, the bid is accepted and the player is assigned to the participant.

### BRIEF DESCRIPTION OF THE DRAWINGS

FIG. 1 is an apparatus for selecting a fantasy team for a fantasy sporting event in accordance with an illustrated embodiment of the invention; and

FIG. 2 is a display of team window provided by the system of FIG. 1.

### DETAILED DESCRIPTION OF AN ILLUSTRATED EMBODIMENT

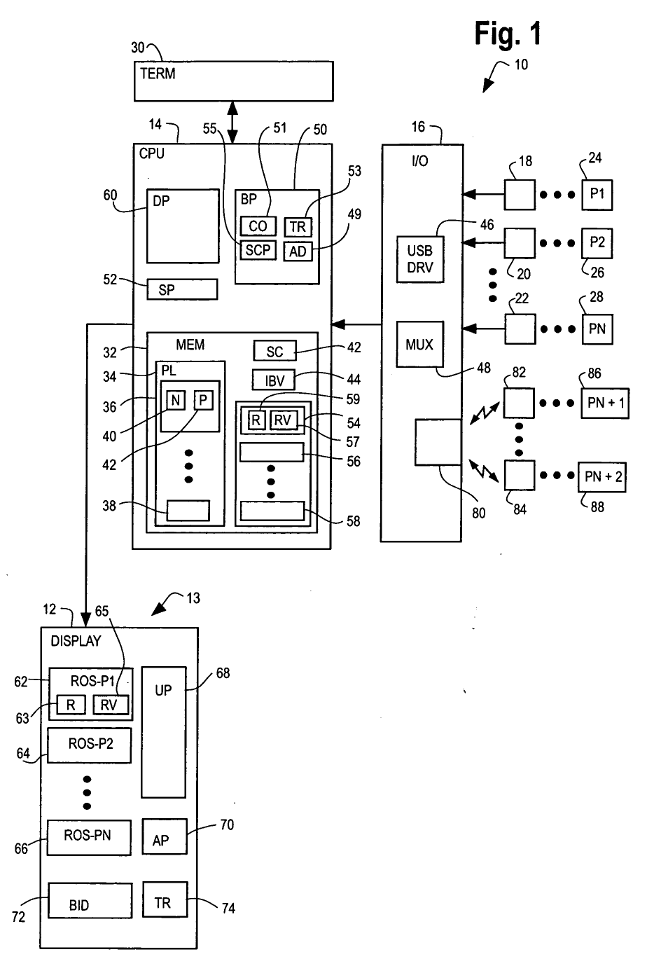

FIG. 1 is a block diagram of a fantasy team auctioning system 10 shown generally in accordance with an illustrated embodiment of the invention. The system 10 may be used for selecting fantasy teams under any sports format (e.g., football, baseball, basketball, etc.).

Included within the system 10 may be an auction display 12, a central processing unit (CPU) 14 and a fantasy game participant interface 16. A number of bidding pushbuttons 18, 20, 22 may be used by fantasy game participants 24, 26, 28 to place offers (bids) on players.

Under a first preferred embodiment, a bidding pushbutton is a contact closure device that closes a single circuit a single time for each activation of the pushbutton. Each activation of the pushbutton results in the current offer for a player being incremented by a predetermined incremental value. If the participant holds the pushbutton in an activated state, then the current offer may be sequentially incremented based upon the time held in the activated state.

The CPU 14 may be a convention personal computer (PC) with custom program features (i.e., software modules) discussed in more detail below. It should be understood in this regard that reference to a program feature also refers to the software module (processor) that provides that feature.

The participant interface 16 may be a custom interface that includes a multiplexer (MUX) 48 and USB driver 46. The MUX 48 may sequentially sample an input from each of the pushbuttons 18, 20, 22 and provide an indicator of the state of the pushbutton (activated or deactivated) to the USB driver 46. The USB driver 46, in turn, may assign a port identifier to each pushbutton 18, 20, 22 and send status information to the CPU 14 regarding the state of each pushbutton 18, 20, 22.

The system 10 may also include a terminal 30 through which the system 10 can be controlled and through which identifiers of participants 24, 26, 28 and salary caps may be entered.

As used herein, a fantasy game participant (participant) is a human participant in a fantasy game involving a sports event. In contrast, a player (athlete) is a human sports figure in a sporting event. A salary cap is a total amount that any participant may spend on players for any one fantasy team.

In general, the auctioning systems for fantasy games of the prior art have been performed in a relatively sterile environment through the Internet, thereby depriving fantasy game participants the benefit and enjoyment of direct interaction. Under one preferred embodiment, the selection of players by fantasy game participants is practiced within a single room or enclosed area with a clear view of the display 12 and where the participants can further enjoy the fantasy game by directly interacting with other fantasy game participants during the auction and by directly observing the results of each participant's progress during the auction on the display 12.

Turning now to the system 10, an operator (or one of the participants 24, 26, 28) working through a control terminal 30 may set up the system 10 for the auction of players. Through the terminal 30, the operator may enter a list of players 36, 38 into a player list 34 located within memory 32. For each player 36, 38, the operator may enter an identifier (e.g., a name) 40 and a game position 42 (e.g., quarterback, kicker, etc.). The operator may also enter a salary cap 44 and an incremental bid value 44.

If not already done so, the operator may also open a file 54, 56, 58 for each participant 24, 26, 28 and associate that file with a particular pushbutton 18, 20, 22. Included within each participant file 54, 56, 58 may be a roster of players 59 and a remaining salary cap value 57.

To associate a pushbutton 18, 20, 22 with a file, the operator may enter a setup mode using a setup mode processor 52. One of the participants 24, 26, 28 may then activate a respective pushbutton 18, 20, 22. In response, the setup processor 52 may provide a window in which an identifier of the participant 24, 26, 28 that has activated the pushbutton 18, 20, 22 may be entered. Once entered, the identifier of the participant 24, 26, 28 and a port identifier of the pushbutton 18, 20, 22 may be collected by the setup processor 52 and used to set up a respective file 54, 56, 58 for the participant 24, 26, 28. A corresponding file for each of the other participants may be set up in a similar manner.

To begin the auction, the operator may enter a bidding mode by activating a bidding and display processor 60. In response, a window may be opened on the operators terminal 30 where the operator is asked to enter an identifier 40 of a player. Upon identifying the player, the bidding processor 60 may take steps to provide a bidding status window 13 on the display 12.

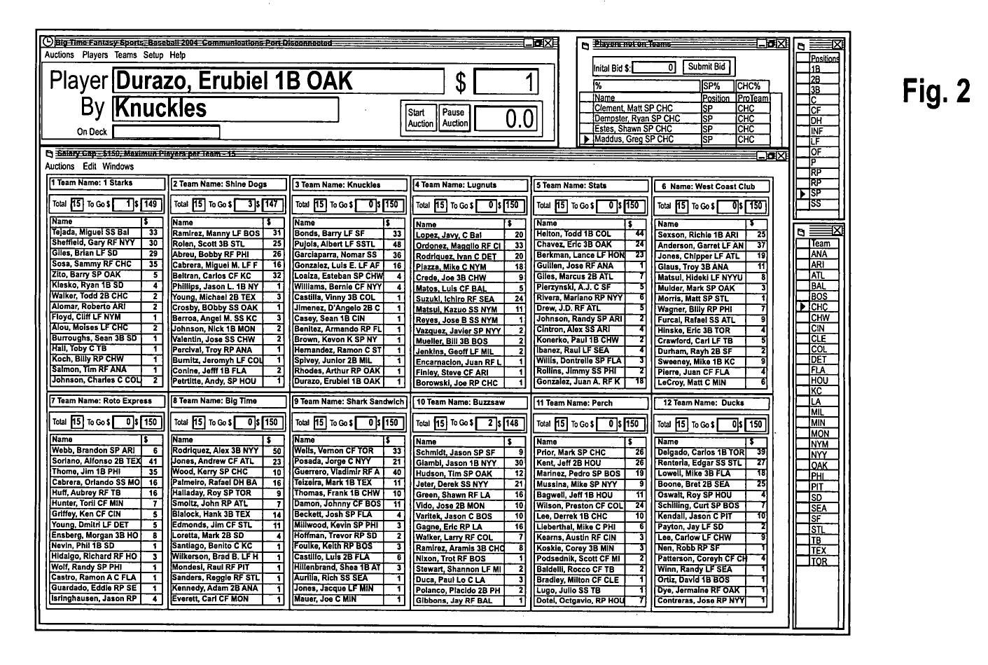

As a first step, the bidding processor 60 may retrieve the participant files 54, 56, 58. From the participant files 54, 56, 58, the bidding processor 60 may provide a respective team window 62, 64, 66 (FIG. 2) for each participant 24, 26, 28. Included within the window 62, 64, 66 may be the identifier of the respective participant 24, 26, 28 as well as team and salary cap status.

Team status may include a list of each player that the respective participant 24, 26, 28 has already obtained through the bidding process. The salary cap status may include a remaining salary cap value after deducting the winning offers spent on previously obtained players.

The bidding processor 60 may also retrieve the list 34 of unassigned players 36, 38 from memory 32, the salary cap 42 and an incremental bid value 44. The list 34 of players 36, 38 may be displayed in an unassigned players window 68.

Also included within the bidding status window 13 may be a current offer window 72 and a time remaining until acceptance of a bid window 74. The current offer window may show the current offer for the current player at auction. The current time window 74 may show the time in seconds until the close of bidding for that player.

In one preferred embodiment, the current time window 74 may be set to some predetermined time value (e.g., 5 seconds). The current time window 74 may remain at the predetermined value until the first bid is received. Once the first bid is received, then the current time window 74 may begin counting down. If another bid is not received before the time value reaches zero, then bidding is closed and the player is assigned to the participant 24, 26, 28 who submitted the first bid. If another offer is received, then the time window 74 is reset and the process repeats.

At the beginning of team selection, the team status windows 62, 64, 66 depict an initialized state. No players will be shown and the remaining salary cap will equal the initial salary cap. An identifier of the first player selected by the operator for auction may be displayed in an available player box 70, the bid window 72 will show zero and the time window 74 will be set to an initialized value.

Once bidding has begun, a participant 24, 26, 28 may activate his pushbutton 18, 20, 22 to make a bid (offer) for the player identified in the window 70. Activation of a pushbutton (e.g., 18) may be detected by the interface 16 and a message may be sent to a bidding application (bidding processor) 50 notifying the bidding processor 50 of the opening bid. In response, the bidding processor 50 may retrieve the incremental bid value (e.g., one dollar) and add that value within an adder 49 to the value within a current offer memory location 51. The display processor 60, in turn, retrieves the current offer and displays that value in the current offer window 72.

The bidding processor 50 may also activate a timer 53 that contains the time remaining until the bid is accepted. The time within timer 53 is displayed in the time remaining window 74.

If, before the predetermined time period has elapsed, a second participant 24, 26, 28 activates his pushbutton 18, 20, 22, then the current offer 51 is again incremented by the incremental bid value 44 and the process repeats. If no further bids are received during the predetermined time period, then the second participant 24, 26, 28 would be deemed to have provided the winning bid and the identifier of the offered player shown in window 70 would be added to the player roster 59 within the participants file 54, 56, 58 and be displayed within a roster window 63 of the team status window 62, 64, 66 of the second participant 24, 26, 28.

The winning bid may also be transferred to a salary cap processing application (processor) 55. The salary cap processor 55 may retrieve a remaining salary cap value 54 from the winning participants file 54, 56, 58 and deduct the winning offer from the remaining salary cap value 57 found within the participants file 54, 56, 58. The remaining salary cap value 57 may be displayed in a remaining value window 65 in the team status window 62, 64, 66.

In contrast to making a single offer, a participant 24, 26, 28 may wish to make an offer that is significantly larger than the current offer shown in window 72. In this case, the participant 24, 26, 28 may simply hold his pushbutton 18, 20, 22 in an activated state. In this case, the bidding processor 50 may increment the current offer 51 by the incremental bid value 44 and check to see if the pushbutton of the participant 24, 26, 28 is still activated. If the bidding processor 50 should determine that the pushbutton 18, 20, 22 remains activated for some predetermined continuing bid period (e.g., 1 second), then the bidding processor 50 may again increment the current offer 51 by the incremental bid value 44. The process may continue until the participant 24, 26, 28 observes the offer that he wants to make within the offer window 72.

Once a selected player is assigned to a participant 24, 26, 28, another unassigned player may be selected and the process may be repeated. Selection of the next unassigned player may be accomplished in any of a number of different ways. Selection may be performed randomly or the participants 24, 26, 28 may take turns selecting players.

As each unassigned player is selected and assigned to participants 24, 26, 28, the winning bid is subtracted from the remaining salary cap value of each winning bidder 24, 26, 28. Once the remaining salary cap value falls below some threshold value, then the bidding processor 50 may reject any further bids from that participant 24, 26, 28.

Bidding may continue until all of the unassigned players have been auctioned off or until there are no more participants 24, 26, 28 with a remaining salary cap value above the threshold. In this regard, one participant 24, 26, 28 may learn from interacting with other participants 24, 26, 28 which players are favored by other participants 24, 26, 28. As part of that participant's strategy, the participant 24, 26, 28 may bid up the favored players of other participants 24, 26, 28 to cause the other participants 24, 26, 28 to deplete their salary cap values very quickly. Using this strategy, the participant 24, 26, 28 may conserve his own salary cap value for the players he/she favors.

Under another illustrated embodiment, the system 10 may be provided with a wireless receiver 80 and a number of wireless transmitters 82, 84. The wireless transmitters 82, 84 and receiver 80 may operate in the infrared or radio frequency range.

The wireless transmitters 82, 84 and wireless receivers 80 may together function as wireless pushbuttons. The identity of the transmitters 82, 84 may be known to the receiver 80 based upon a wireless code assigned to each transmitter 82, 84. Association of a transmitter 82, 84 to a participant 86, 88 may occur as above by having the participant 86, 88 activate the transmitter 82, 84 at the same time that the operator enters an identifier of the participant 86, 88.

As with the pushbuttons 18, 20, 22, activation of a wireless transmitter 82, 84 has the same effect of closing a single circuit a single time for each activation of the transmitter 82, 84. As such, the transmitters 82, 84 function in substantially the same way as the pushbuttons 18, 20, 22.

A specific embodiment of a method and apparatus for auctioning players for a fantasy game has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of selecting a fantasy team for a fantasy sporting event, such method comprising:
a) providing a fantasy team selection processor;
b) providing a bidding pushbutton coupled to the fantasy team selection processor for each of a plurality of participants in the fantasy game;
c) detecting a bid from a participant of the plurality of participants for a player;
d) adding an incremental bid value of the detected bid to a current bid offer;
e) waiting a predetermined time period of time;
f) if another bid is received during the predetermined time period, then repeating steps d, e and f, otherwise, accepting the bid as a winning offer from the participants; and
g) assigning the player to the participant providing the winning offer.

2. The method of selecting the fantasy team as in claim 1 further comprising providing a salary cap for each participant of the plurality of participants.

3. The method of selecting the fantasy team as in claim 3 further comprising deducting the winning offer from the salary cap of the participant providing the winning offer to provide a remaining salary cap for the participant.

4. The method of selecting the fantasy team as in claim 3 further comprising discarding any detected bids from a participant with a remaining salary cap that is less than a predetermined threshold value.

5. The method of selecting the fantasy team as in claim 4 further comprising measuring a time period that the pushbutton of the participant is activated and, each time that the measured time period exceeds an integral multiple of a predetermined pushbutton activation period, incrementing the current bid by the incremental bid value.

6. The method of selecting the fantasy team as in claim 5 further comprising rejecting any bids from any other participant of plurality of participants so long as the pushbutton remains activated.

7. The method of selecting the fantasy team as in claim 1 further comprising providing a plurality of players from which the assigned player is selected.

8. The method of selecting the fantasy team as in claim 7 further comprising providing a display that shows a fantasy team for each participant of the plurality of participants.

9. The method of selecting the fantasy team as in claim 8 further comprising adding the assigned player to a display of the participant of the plurality of participants that provides the winning offer.

10. The method of selecting the fantasy team as in claim 9 wherein the step of assigning the player to the display further comprises selecting another player of the plurality of players for assignment to another participant of the plurality of participants upon receiving a winning offer from the other participant.

11. An apparatus for of selecting a fantasy team for a fantasy sporting event, such method comprising:
a fantasy team selection processor;
a bidding pushbutton coupled to the fantasy team selection processor for each of a plurality of participants in the fantasy game;
means for detecting a bid from a participant of the plurality of participants for a player;
means for adding an incremental bid value of the detected bid to a current bid offer;
means for waiting a predetermined time period of time after receipt of the detected bid;
means for assigning the player to the participant providing the bid, said means for detecting, means for adding and means for assigning being further adapted so that if another bid is received during the predetermined time period, then redefining the other bid as the bid, adding the incremental bid value to the current offer and resetting the means for waiting, otherwise, accepting the bid as a winning offer from the participant.

12. The apparatus for selecting the fantasy team as in claim 11 further comprising a salary cap that is provided for each participant of the plurality of participants.

13. The apparatus for selecting the fantasy team as in claim 12 further comprising means for deducting the winning offer from the salary cap of the participant providing the winning offer to provide a remaining salary cap for the participant.

14. The apparatus for selecting the fantasy team as in claim 13 further comprising means for discarding any detected bids from a participant with a remaining salary cap that is less than a predetermined threshold value.

15. The apparatus for selecting the fantasy team as in claim 14 further comprising means for measuring a time period that the pushbutton of the participant is activated and, each time that the measured time period exceeds a continuing bid period, incrementing the current bid by the incremental bid value.

16. The apparatus for selecting the fantasy team as in claim 15 further comprising means for rejecting any bids from any other participant of plurality of participants so long as the pushbutton remains activated.

17. The apparatus for selecting the fantasy team as in claim 11 further comprising a plurality of players from which the assigned player is selected.

18. The apparatus for selecting the fantasy team as in claim 17 further comprising a display that shows a fantasy team for each participant of the plurality of participants.

19. The apparatus for selecting the fantasy team as in claim 18 further comprising means for adding the assigned player to a display of the participant of the plurality of participants that provides the winning offer.

20. The apparatus for selecting the fantasy team as in claim 19 wherein the means for adding the player to the display further comprises means for selecting another player of the plurality of players for assignment to another participant of the plurality of participants upon receiving a winning offer from the other participant.

21. An apparatus for of selecting a fantasy team for a fantasy sporting event, such method comprising:
a fantasy team selection processor;
a bidding pushbutton coupled to the fantasy team selection processor for each of a plurality of participants in the fantasy game;
a bid processor adapted to detect a bid from a participant of the plurality of participants for a player;
an adder adapted to add an incremental bid value of the detected bid to a current bid offer;
a timer adapted to wait a predetermined time period of time after receipt of the detected bid;
a roster of the participant providing the bid adapted to receive an identifier of the player, said bid processor being further adapted so that if another bid is received during the predetermined time period, the other bid is redefined as the bid, the incremental bid value is again added to the current offer and the timer is reset, otherwise, the bid is accepted as a winning offer from the participant.

22. The apparatus for selecting the fantasy team as in claim 21 further comprising a salary cap that is provided for each participant of the plurality of participants.

23. The apparatus for selecting the fantasy team as in claim 22 further comprising a salary cap processor adapted to deduct the winning offer from the salary cap of the participant providing the winning offer to provide a remaining salary cap for the participant.

24. The apparatus for selecting the fantasy team as in claim 23 further comprising the bidding processor being further adapted to measure a time period that the pushbutton of the participant is activated and, each time that the measured time period exceeds a continuing bid period, incrementing the current bid by the incremental bid value.

25. The apparatus for selecting the fantasy team as in claim 24 further comprising the bidding processor being further adapted to reject any bids from any other participant of plurality of participants so long as the pushbutton remains activated.

26. The apparatus for selecting the fantasy team as in claim 21 further comprising a plurality of players from which the assigned player is selected.

27. The apparatus for selecting the fantasy team as in claim 26 further comprising a display that shows a fantasy team for each participant of the plurality of participants.

28. The apparatus for selecting the fantasy team as in claim 27 further comprising a team window that shows the assigned player.
